(19) United States
(12) Patent Application Publication
(10) Pub. No.: US 2013/0016069 A1
(43) Pub. Date: Jan. 17, 2013

(54) OPTICAL IMAGING DEVICE AND IMAGING PROCESSING METHOD FOR OPTICAL IMAGING DEVICE

(71) Applicants: Yu-Yen Chen, New Taipei City (TW); Po-Liang Huang, New Taipei City (TW)

(72) Inventors: Yu-Yen Chen, New Taipei City (TW); Po-Liang Huang, New Taipei City (TW)

(21) Appl. No.: 13/531,597

(22) Filed: Jun. 25, 2012

(30) Foreign Application Priority Data
Jul. 15, 2011 (TW) 100125095

(51) Int. Cl. G06F 3/042

(52) U.S. Cl. 345/175

(57) ABSTRACT

An optical imaging device includes a display panel whereon a coordinate detecting area is formed, at least one light source disposed on a corner of the display panel for emitting light to illuminate an object, a first image capturing module disposed on a corner of the display panel for capturing image information of the object, a second image capturing module disposed on another corner of the display panel for capturing image information of the object, and a control module coupled to the first image capturing module and the second image capturing module for determining whether to calculate a coordinate value of the object according to whether the first image capturing module and the second image capturing module capture the image information of the object simultaneously.

### BACKGROUND OF THE INVENTION

1. Field of the Invention

The Present invention relates to an optical imaging device and an imaging processing method, and more particularly, to an optical imaging device and an imaging processing method without using a reflecting frame.

2. Description of the Prior Art

In the modern consumer electronic products, a portable electronic product such as a personal digital assistant, a smart phone or a mobile phone is equipped with a touch control device as an interface for data transmission. Since consumer electronic products have become lighter, thinner, shorter and smaller, there is no space on these products for containing a conventional input device, such as a mouse, a keyboard and so on. Furthermore, with development of tablet computers focusing on humanity design, a display with the touch control device has gradually become one of the key components in various electronic products. A variety of touch control technologies, such as a resistive type, a capacitive type, an ultrasonic type, an infrared type, an optical imaging type and so on have been developing. Due to consideration for technology level and cost, the above-mentioned touch control technologies have been implemented in various fields.

For example, principle of the optical imaging design is to utilize two image capturing modules located at two corners of the display for detecting a position of an object on the display. Then, the position of the object on the display is calculated by triangulating location. Thus, compared with the conventional resistive type or capacitive type touch device, it has advantages of accuracy, high penetration, good stability, low damage rate, low cost and being capable of multi-touch, and the optical imaging design is overwhelmingly advantageous in the large-size display market. However the conventional optical imaging touch device needs a reflecting frame as a photographic background when the object is located within a coordinate detecting area, to isolate interference outside the coordinate detecting area. The object blocks the light reflected from the reflecting frame as locating within the coordinate detecting area so as to detect a shadow by a sensor, for getting the position of the object by the position of the shadow. In other words, the reflecting frame provides the function of blocking the interference and difference between the object and the background. However, the reflecting frame and the sensor have to be installed on the same plane, resulting in difficulty in assembly and increasing manufacturing cost . But it is not easy to determine the object without the reflecting frame due to the interference outside the coordinate detecting area. As a result, design of an optical imaging device for effectively decreasing assembly difficulties and cost and for increasing determining accuracy is an important issue of the touch technology.

### SUMMARY OF THE INVENTION

The present invention provides an optical imaging device without using a reflecting frame and an image processing method to solve the above problems.

According to the disclosure, an optical imaging device includes a display panel whereon a coordinate detecting area is formed, at least one light source disposed on a corner of the display panel for emitting light to illuminate an object, a first image capturing module disposed on a corner of the display panel for capturing image information of the object, a second image capturing module disposed on another corner of the display panel for capturing image information of the object, and a control module coupled to the first image capturing module and the second image capturing module for determining whether to calculate a coordinate value of the object according to whether the first image capturing module and the second image capturing module capture the image information of the object simultaneously.

According to the disclosure, the optical imaging device further includes at least one light diffusing component disposed on a side of the at least one light source for diffusing the light emitted from the at least one light source so as to generate a planar light beam.

According to the disclosure, the at least one light source is a laser light emitting diode or an infrared light emitting diode for emitting a straight light beam.

According to the disclosure, the planar light beam generated by the at least one light diffusing component is substantially parallel to the display panel.

According to the disclosure, the control module does not calculate the coordinate value of the object when the first image capturing module and the second image capturing module do not capture the image information of the object simultaneously.

According to the disclosure, the control module calculates the coordinate value of the object when the first image capturing module and the second image capturing module capture the image information of the object simultaneously.

According to the disclosure, the control module is further for determining whether the object is located within the coordinate detecting area according to the calculated coordinate value of the object.

According to the disclosure, an included angle is formed between the planar light beam generated by the at least one light diffusing component and the display panel so that the planar light beam generated by the at least one light diffusing component projects onto the coordinate detecting area substantially.

According to the disclosure, the control module is further for determining whether to calculate the coordinate value of the object according to whether the image information of the object captured by the first image capturing module or the second image capturing module is greater than a threshold value.

According to the disclosure, the control module does not calculate the coordinate value of the object when the image information of the object captured by the first image capturing module or the second image capturing module is less than the threshold value.

According to the disclosure, the control module calculates the coordinate value of the object when the image information of the object captured by the first image capturing module or the second image capturing module is greater than the threshold value and the first image capturing module and the second image capturing module capture the image information of the object simultaneously.

According to the disclosure, the image capturing module is an image sensor.

According to the disclosure, an image processing method for an optical imaging device includes the following steps: at least one light source of the optical imaging device emitting light to illuminate an object, a first image capturing module and a second image capturing module of the optical imaging device capturing image information of the object, and a control module of the optical imaging device determining whether to calculate a coordinate value of the object according to whether the first image capturing module and the second image capturing module capture the image information of the object simultaneously.

The present invention provides the optical imaging device and the image processing method without using a reflecting frame and capable of achieving the purpose of filtering out the object not located within the coordinate detecting area, and therefore it can overcome the assembly difficulty, reduce the manufacturing cost, and have the accurate determination of the touch object with image processing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an optical imaging device according to a first embodiment of the present invention.

FIG. 2 and FIG. 3 are respectively a front view and a side view of the optical imaging device according to the first embodiment of the present invention.

FIG. 4 is a diagram showing a plurality of objects located in different positions of the optical imaging device according to first embodiment of the present invention.

FIG. 5 is a flowchart of an image processing method executed by the optical imaging device according to the first embodiment of the present invention.

FIG. 6 is a side view of an optical imaging device according to a second embodiment of the present invention.

FIG. 7 is a diagram showing the plurality of objects located in different positions of the optical imaging device according to the second embodiment of the present invention.

FIG. 8 is a flowchart of an image processing method executed by the optical imaging device according to the second embodiment of the present invention.

### DETAILED DESCRIPTION

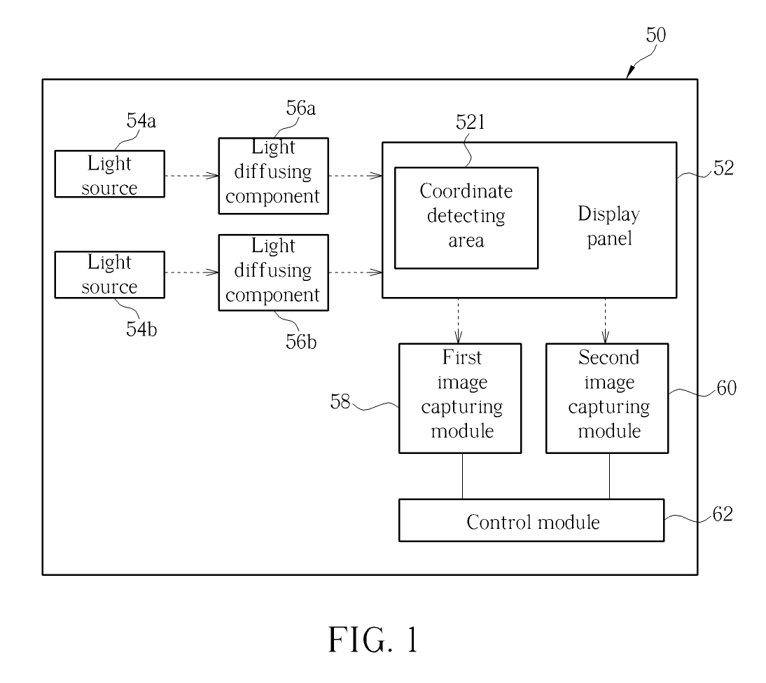

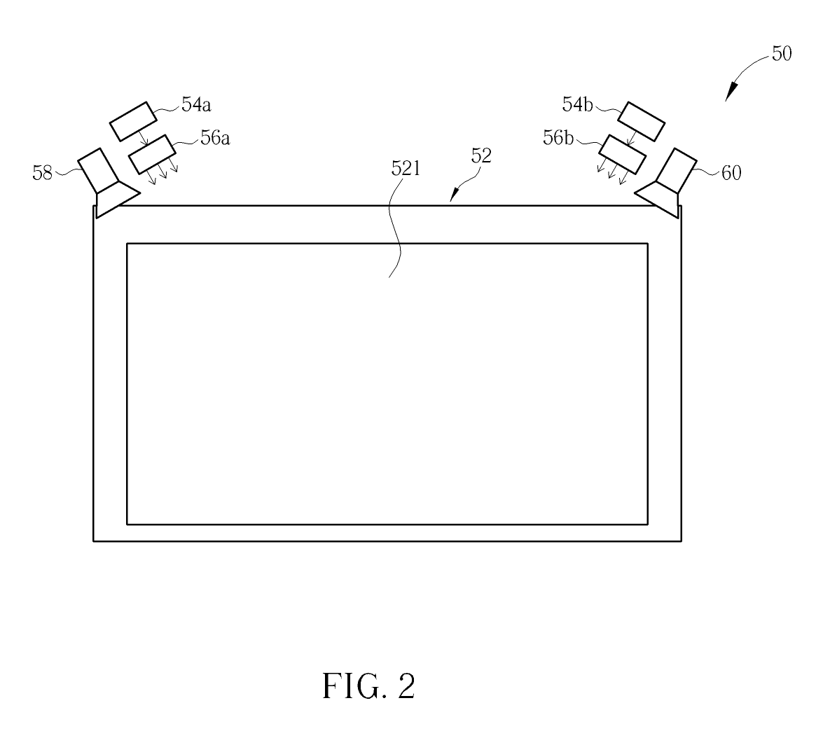

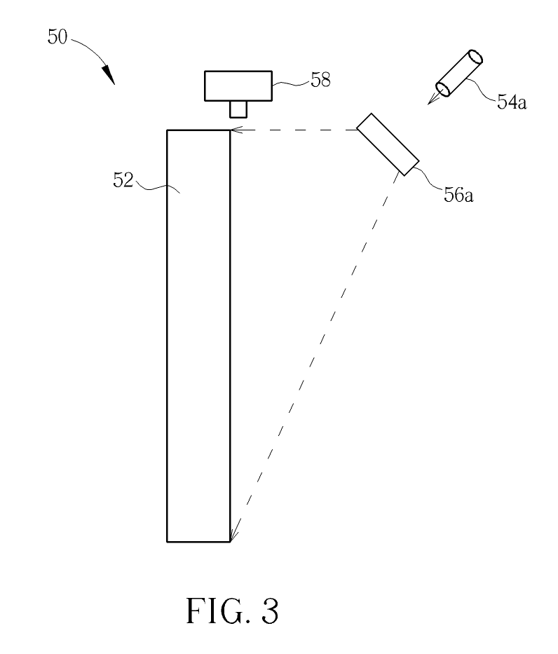

Please refer to FIG. 1 to FIG. 3. FIG. 1 is a functional block diagram of an optical imaging device 50 according to a first embodiment of the present invention, and FIG. 2 and FIG. 3 are respectively a front view and a side view of the optical imaging device 50 according to the first embodiment of the present invention. The optical imaging device 50 includes a display panel 52, two light sources 54a, 54b, two diffusing components 56a, 56b, a first image capturing module 58, a second image capturing module 60 and a control module 62. The display panel 52 can be a touch panel whereon a coordinate detecting area 521 is formed. The two light sources 54a, 54b, are disposed on two outside corners of the display panel 52 respectively and used for emitting light so as to illuminate an object. The two light sources 54a, 54b can be respectively a laser light emitting diodes or an infrared light emitting diode and used for emitting a collimated beam. The two light diffusing components 56a, 56b are used for diffusing the light emitted from the two light sources 54a, 54b respectively so as to generate planar light beams. The location and amount of the light source and the diffusing component are not limited to the embodiment described above, and it depends on the requirement on actual design.

The first image capturing module 58 and the second image capturing module 60 are installed on different corners of the display panel 52 respectively, and the first image capturing module 58 and the second image capturing module 60 are used for capturing image information of the object. The first image capturing module 58 and the second image capturing module 60 can be an image sensor respectively, such as a camera and so on. The control module 62 is coupled to the first image capturing module 58 and the second image capturing module 60, and the control module 62 receives image information captured by first image capturing module 58 and the second image capturing module 60 so as to calculate a coordinate value of the object. The display panel 52, the two light sources 54a, 54b, the two light diffusing components 56a, 56b, the first image capturing module 58, the second image capturing module 60 and the control module 62 can be integrated within the same display, such as being within a monitor or an All In One PC and so on. The two light sources 54a, 54b, the two light diffusing components 56a, 56b, the first image capturing module 58, the second image capturing module 60 and the control module 62 also can be modularized separately, such as hanging on a frame of the display panel 52, and the coordinate detecting area 521 can correspond to a transparent panel on the frame, so that it can be disassembled and installed on the different display panel 52.

In order to implement the optical imaging device 50, users can perform touch operation within the coordinate detecting area 521, such as moving fingers within the coordinate detecting area 521. In this embodiment, the two light sources 54a, 54b and the two diffusing components 56a, 56b are away from the display panel 52 with a specific distance, resulting in an included angle formed between the planar beams generated from the two diffusing components 56a, 56b and the display panel 52, so that the planar beams generated from the two diffusing components 56a, 56b can project onto the coordinate detecting area 521 or its nearby area substantially. In other words, the illuminating area corresponds to the coordinate detecting area 521, and there is no light passing through the outside far away from the coordinate detecting area 521.

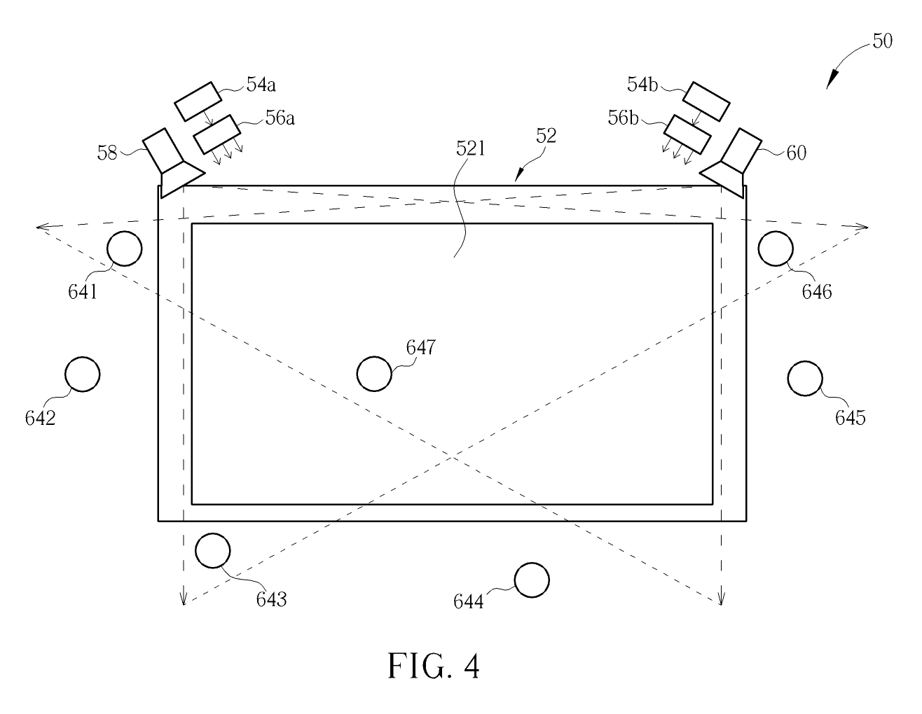

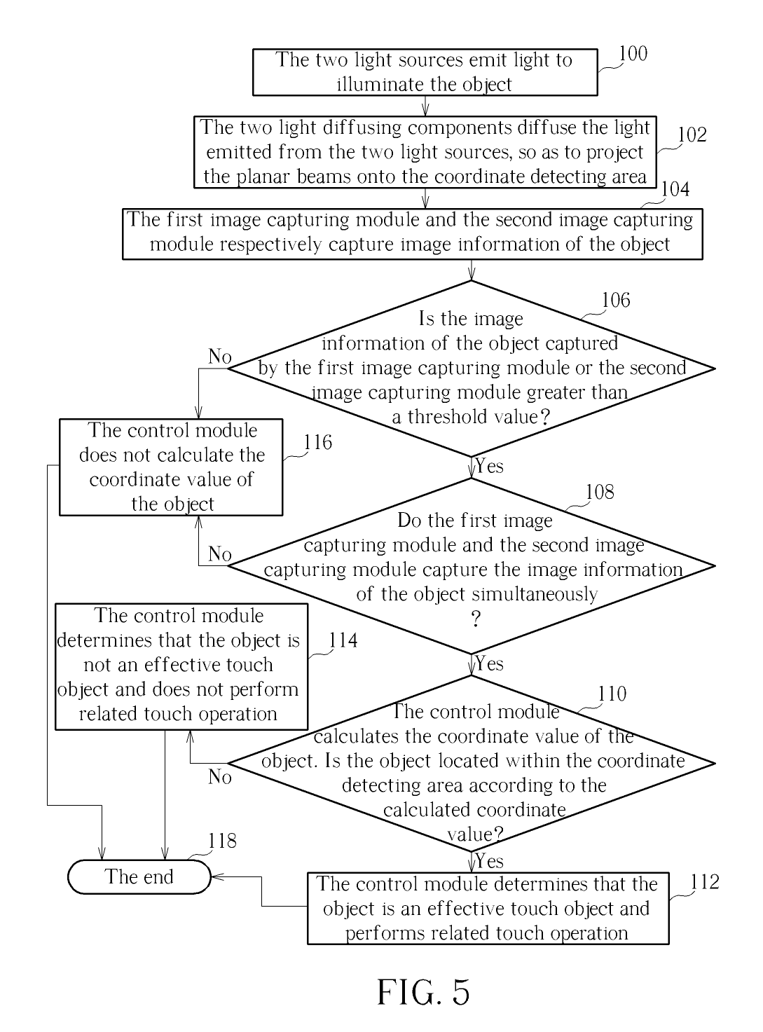

Please refer to FIG. 4 and FIG. 5. FIG. 4 is a diagram showing a plurality of objects 641-647 located in different locations of the optical imaging device 50 according to the first embodiment of the present invention. FIG. 5 is a flowchart of an image processing method executed by the optical imaging device 50 according to the first embodiment of the present invention. The method includes following steps:

Step 100: The two light sources 54a, 54b emit light to illuminate the object.

Step 102: The two diffusing components 56a, 56b diffuse the light emitted from the two light sources 54a, 54b, so as to project the planar beams onto the coordinate detecting area 521.

Step 104: The first image capturing module 58 and the second image capturing module 60 respectively capture the image information of the object.

Step 106: The control module 62 determines whether the image information of the object captured by the first image capturing module 58 or the second image capturing module 60 is greater than a threshold value. If yes, perform step 108; if no, go to step 116.

Step 108: The control module 62 determines whether the first image capturing module 58 and the second image capturing module 60 capture the image information of the object simultaneously. If yes, perform step 110; if no, go to step 116.

Step 110: The control module 62 calculates the coordinate value of the object and determines whether the object is located within the coordinate detecting area 521 according to the calculated coordinate value. If yes, perform step 112; if no, go to step 114.

Step 112: The control module 62 determines that the object is an effective touch object and performs related touch operation.

Step 114: The control module 62 determines that the object is not an effective touch object and does not perform related touch operation.

Step 116: The control module 62 does not calculate the coordinate value of the object.

Step 118: The end.

Detailed introduction is described as follows. At first, the first two light sources 54a, 54b can emit collimated beams respectively, and the two diffusing components 56a, 56b can respectively diffuse the beams emitted from the two light sources 54a, 54b, so as to generate the linear planar beams . In this embodiment, a specific included angle is formed between the planar beams generated from the two diffusing components 56a, 56b and the display panel 52, and therefore the planar beams generated from the two diffusing components 56a, 56b project onto the coordinate detecting area 521 or its nearby area substantially. That is, the illuminating area corresponds to the coordinate detecting area 521, and there is no light passing through the outside far away from the coordinate detecting area 521.

Next, the first image capturing module 58 and the second image capturing module 60 will capture the image information of the object respectively. Taking FIG. 4 as an example, because the objects 642, 644, 645 are located in the outside far away from the coordinate detecting area 521, the objects 642, 644, 645 can not be illuminated by beams or only be illuminated by weak beams, so that the control module 62 will determine that the image information of the objects 642, 644, 645 (such as the signal intensity of the image information of the objects) captured by the first image capturing module 58 or the second image capturing module 60 is less than a threshold value (or the first image capturing module 58 or the second image capturing module 60 can not capture the image information of the objects), and then does not perform corresponding image processing procedure. It means the objects 642, 644, 645 are not located within the coordinate detecting area 521, so the control module 62 will not calculate the coordinate values of the objects 642, 644, 645.

On the contrary, because the objects 641, 643, 646, 647 are located within the coordinate detecting area 521 or its nearby area, the objects 641, 643, 646, 647 can be illuminated by the beams and the control module 62 will determine that the image information of the objects 641, 643, 646, 647 captured by the first image capturing module 58 or the second image capturing module 60 is greater than the threshold value, so as to perform corresponding image processing procedure. The setting of the threshold value can depend on error tolerance or image processing calculation. For example, the threshold value can be set higher so as to filter out the unnecessary location of the object for less image processing calculation.

Next, the control module 62 will determine whether the first image capturing module 58 and the second image capturing module 60 capture the image information of the objects 641,643,646,647 simultaneously. In this embodiment, the first image capturing module 58 and the second image capturing module 60 can capture the image information of the objects 643, 647 simultaneously but cannot capture the image information of the objects 641, 646 simultaneously, which means that the first image capturing module 58 can capture the image information of the object 646 but cannot capture the image information of the object 641, and the second image capturing module 60 can capture the image information of the object 641 but can not capture the image information of the object 646. Because the intersection of capturing ranges of the first image capturing module 58 and the second image capturing module 60 can cover the coordinate detecting area 521 substantially, the image information of the objects not captured simultaneously by the first image capturing module 58 and the second image capturing module 60 can be filtered out, which means the objects 641, 646 are not located within the coordinate detecting area 521, so that the control module 62 will not calculate the coordinate values of the objects 641, 646. On the contrary, the first image capturing module 58 and the second image capturing module 60 can capture the image information of the objects 643,647 simultaneously, and therefore the corresponding image processing procedure will be executed.

Finally, the control module 62 will calculate the coordinate value of the objects 643, 647. For example, the control module 62 can perform image processing analysis for the image information of the object 643, 647 first, such as noise reduction, and then perform coordinate transformation of the processed image information, such as getting the position of the objects 643, 647 according to the included angles between the captured images by the first image capturing module 58 and the second image capturing module 60 and axes by triangulating location, so as to get the corresponding coordinate values. The control module 62 can determine whether the objects are located within the coordinate detecting area 521 according to the calculated coordinate value. In this embodiment, the calculated coordinate value of the object 643 is located outside the coordinate detecting area 521, so as to determine the objects 643 is not located within the coordinate detecting area 521, which means that the control module 62 determine that the object 643 is not an effective touch object and does not perform the touch operation. The calculated coordinate value of the object 647 is located within the coordinate detecting area 521, so the control module 62 will determine that the object 647 is an effective touch object and provide the host computer with a basis to perform the related touch operation.

In summary, by determining whether the image information of the object captured by the first image capturing module 58 or the second image capturing module 60 is greater than the threshold value, determining whether the first image capturing module 58 and the second image capturing module 60 can capture the image information of the object simultaneously, and determining whether the calculated coordinate value is located within the coordinate detecting area 521, the object without the possibility of locating within the coordinate detecting area 521 can be excluded, so as to filter out unnecessary calculation of objects for effectively conserve system resources, and it can accurately determine the objects located within the coordinate detecting area 521, and then perform related touch operation.

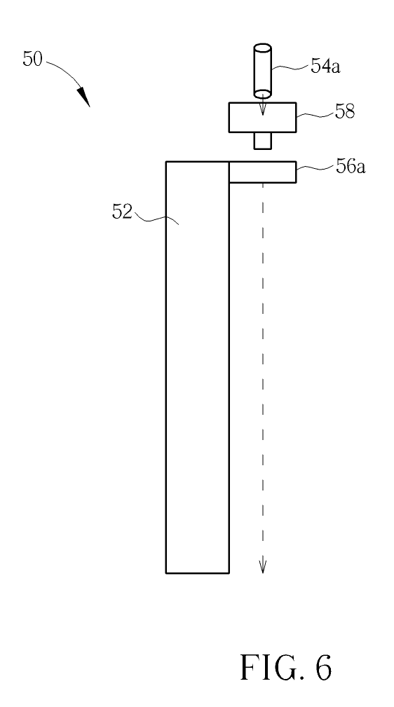

Please refer to FIG. 6. FIG. 6 is a side view of an optical imaging device 100 according to a second embodiment of the present invention. The difference between the foregoing embodiment and this embodiment is that the two light sources 54a, 54b and the two light diffusing components 56a, 56b are close to the display panel 52 so that the planar beams generated from the two light diffusing components 56a, 56b is substantially parallel to the display panel 52, and therefore the planar beams generated from the two light diffusing components 56a, 56b can not correspond to the coordinate detecting area 521, which means that the object 641 to 647 are all to be illuminated by the planar beams, so that step 106 of foregoing embodiment is not performed because any object can not be filtered out in step 106.

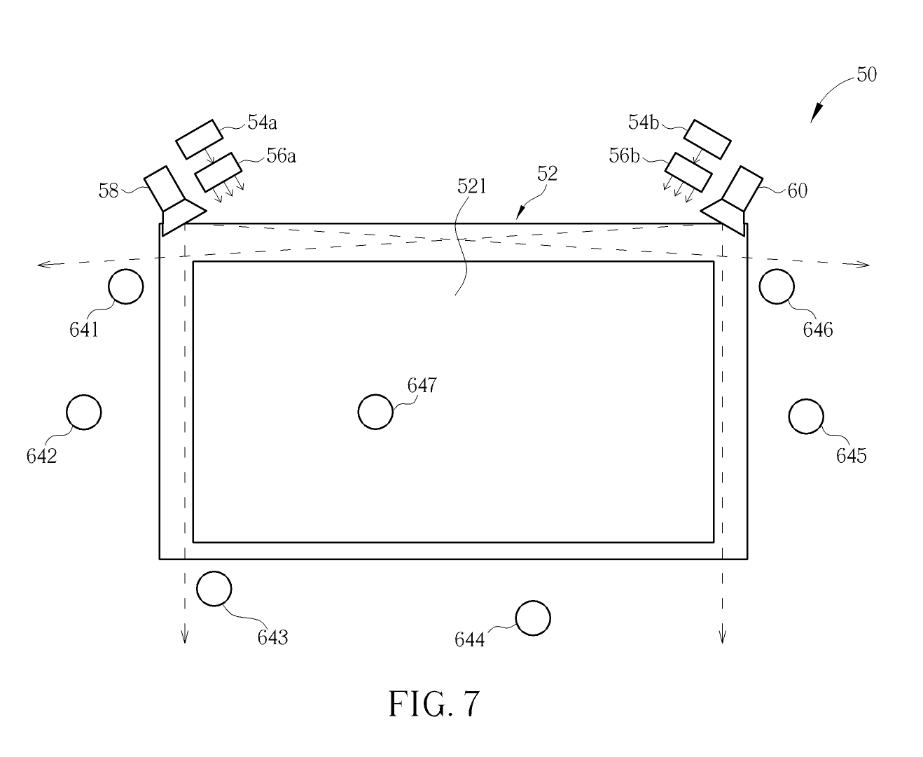

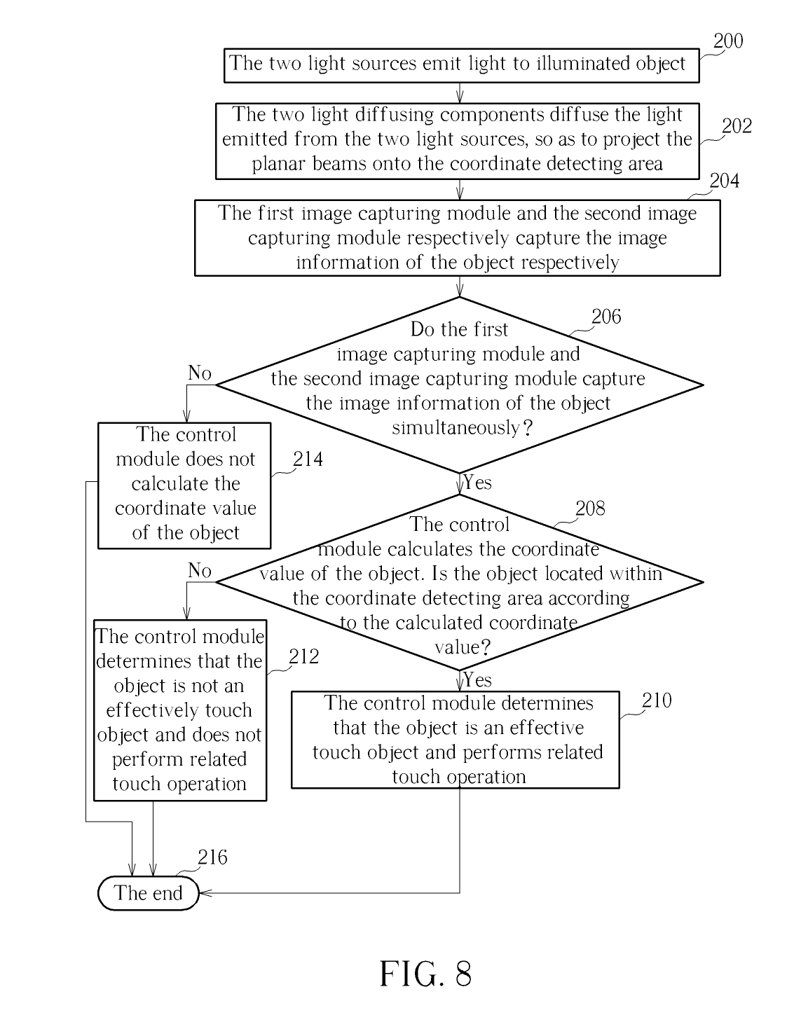

Please refer to FIG. 7. FIG. 7 is a diagram showing the plurality of objects 641-647 located in different locations of the optical imaging device 100 according to the second embodiment of the present invention. FIG. 8 is a flowchart of an image processing method executed by the optical imaging device 100 according to the second embodiment of the present invention. The method includes following steps:

Step 200: The two light sources 54a, 54b emit light to illuminate object.

Step 202: The two diffusing components 56a, 56b diffuse the light emitted from the two light sources 54a, 54b, so as to project the planar beams onto the coordinate detecting area 521.

Step 204: The first image capturing module 58 and the second image capturing module 60 respectively capture the image information of the object.

Step 206: The control module 62 determines whether the first image capturing module 58 and the second image capturing module 60 capture the image information of the object simultaneously. If yes, perform step 208; if no, go to step 214.

Step 208: The control module 62 calculates the coordinate value of the object and determines whether the object is located within the coordinate detecting area 521 according to the calculated coordinate value. If yes, perform step 210; if no, go to step 212.

Step 210: The control module 62 determines that the object is an effective touch object and performs related touch operation.

Step 212: The control module 62 determines that the object is not an effectively touch object and does not perform related touch operation.

Step 214: The control module 62 does not calculate the coordinate value of the object.

Step 216: The end.

Detailed introduction is described as follows. As the foregoing embodiment, at first the two light sources 54a, 54b can emit the collimated beams respectively, and the two diffusing components 56a, 56b can respectively diffuse the beams emitted from the two light sources 54a, 54b so as to generate the planar beams. In this embodiment, the planar beams generated from the diffusing components 56a, 56b are substantially parallel to the display panel 52, and therefore the planar beams generated from the diffusing components 56a, 56b can not correspond to the coordinate detecting area 521, which means the objects 641-647 can be illuminated by the beams, so that the objects 641-647 all will be performed in corresponding image processing procedure.

Next, the first image capturing module 58 and the second image capturing module 60 will capture the image information of the objects respectively, and the control module 62 will determine whether the first image capturing module 58 and the second image capturing module capture the image information of the objects 641 to 647 simultaneously. In this embodiment, the first image capturing module 58 and the second image capturing module 60 can capture the image information of the objects 643, 644, and 647 simultaneously but can not capture the image information of the objects 641, 642, 645, and 646 simultaneously, which means that the first image capturing module 58 can capture the image information of the objects 645, 646 but can not capture the image information of the objects 641, 642, and the second image capturing module 60 can capture the image information of the objects 641, 642 but can not capture the image information of the objects 645, 646. Because the intersection of capturing ranges of the first image capturing module 58 and the second image capturing module 60 can cover the coordinate detecting area 521 substantially, the image information of the objects not captured by the first image capturing module 58 and the second image capturing module 60 can be filtered out, which means the objects 641, 642, 645, 646 are not located within the coordinate detecting area 521, so that the control module 62 will not calculate the coordinate values of the objects 641, 642, 645, 646. On the contrary, the first image capturing module 58 and the second image capturing module 60 can capture the image information of the objects 643, 644, 647 simultaneously, and therefore the corresponding image processing procedure will be executed.

Finally, the control module 62 calculates the coordinate values of the object 643, 644, 647. In this embodiment, the calculated coordinate values of the object 643, 644 are outside the coordinate detecting area 521, so the object 643, 644 without the possibility of locating within the coordinate detecting area 521 can be excluded, which means that the control module 62 determines that the object 643, 644 are not effective touch objects and does not perform related touch operation. The calculated coordinate value of the object 647 is located within the coordinate detecting area 521, so the control module 62 will determine the object 647 is an effective touch object and provide the host computer with a basis to perform the related touch operation.

In summary, by determining whether the first image capturing module 58 and the second image capturing module 60 can capture the image information of the object simultaneously, and determining whether the calculated coordinate value is located within the coordinate detecting area 521, the object without the possibility of locating within the coordinate detecting area 521 can be excluded, so as to filter out unnecessary calculation of objects for effectively conserve system resources, and it can accurately determine the objects located within the coordinate detecting area 521, and then perform related touch operation.

Compared to the prior art, the present invention provides the optical imaging device and the image processing method without using the reflecting frame and capable of achieving the purpose of filtering out the object not located within the coordinate detecting area, and therefore it can overcome the assembly difficulty, reduce the manufacturing cost, and have the accurate determination of the touch object with image processing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging device comprising:
a display panel whereon a coordinate detecting area is formed;
at least one light source disposed on a corner of the display panel for emitting light to illuminate an object;
a first image capturing module disposed on a corner of the display panel for capturing image information of the object;
a second image capturing module disposed on another corner of the display panel for capturing image information of the object; and
a control module coupled to the first capturing module and the second capturing module for determining whether to calculate a coordinate value of the object according to whether the first image capturing module and the second image capturing module capture the image information of the object simultaneously.

2. The optical imaging device of claim 1, further comprising at least one light diffusing component disposed on a side of the at least one light source for diffusing the light emitted from the at least one light source so as to generate a planar light beam.

3. The optical imaging device of claim 2, wherein the at least one light source is a laser light emitting diode or an infrared light emitting diode for emitting a straight light beam.

4. The optical imaging device of claim 2, wherein the planar light beam generated by the at least one light diffusing component is substantially parallel to the display panel.

5. The optical imaging device of claim 4, wherein the control module does not calculate the coordinate value of the object when the first image capturing module and the second image capturing module do not capture the image information of the object simultaneously.

6. The optical imaging device of claim 4, wherein the control module calculates the coordinate value of the object when the first image capturing module and the second image capturing module capture the image information of the object simultaneously.

7. The optical imaging device of claim 6, wherein the control module is further for determining whether the object is located within the coordinate detecting area according to the calculated coordinate value of the object.

8. The optical imaging device of claim 2, wherein an included angle is formed between the planar light beam generated by the at least one light diffusing component and the display panel so that the planar light beam generated by the at least one light diffusing component projects onto the coordinate detecting area substantially.

9. The optical imaging device of claim 8, wherein the control module is further for determining whether to calculate the coordinate value of the object according to whether the image information of the object captured by the first image capturing module or the second image capturing module is greater than a threshold value.

10. The optical imaging device of claim 9, wherein the control module does not calculate the coordinate value of the object when the image information of the object captured by the first image capturing module or the second image capturing module is less than the threshold value.

11. The optical imaging device of claim 9, wherein the control module calculates the coordinate value of the object when the image information of the object captured by the first image capturing module or the second image capturing module is greater than the threshold value and the first image capturing module and the second image capturing module capture the image information of the object simultaneously.

12. The optical imaging device of claim 11, wherein the control module is further for determining whether the object is located within the coordinate detecting area according to the calculated coordinate value of the object.

13. An image processing method for an optical imaging device, comprising:
at least one light source of the optical imaging device emitting light to illuminate an object;
a first image capturing module and a second image capturing module of the optical imaging device capturing image information of the object; and
a control module of the optical imaging device determining whether to calculate a coordinate value of the object according to whether the first image capturing module and the second image capturing module capture the image information of the object simultaneously.

14. The image processing method of claim 13, further comprising at least one light diffusing component of the optical imaging device diffusing the light emitted from the at least one light source so as to generate a planar light beam.

15. The image processing method of claim 13, wherein the control module of the optical imaging device determining whether to calculate the coordinate value of the object according to whether the first image capturing module and the second image capturing module capture the image information of the object simultaneously comprises the control module not calculating the coordinate value of the object when the first image capturing module and the second image capturing module do not capture the image information of the object simultaneously.

16. The image processing method of claim 13, wherein the control module of the optical imaging device determining whether to calculate the coordinate value of the object according to whether the first image capturing module and the second image capturing module capture the image information of the object simultaneously comprises the control module calculating the coordinate value of the object when the first image capturing module and the second image capturing module capture the image information of the object simultaneously.

17. The image processing method of claim 16, further comprising the control module determining whether the object is located within the coordinate detecting area according to the calculated coordinate value of the object.

18. The image processing method of claim 13, further comprising the control module determining whether to calculate the coordinate value of the object according to whether the image information of the object captured by the first image capturing module or the second image capturing module is greater than a threshold value.

19. The image processing method of claim 18, wherein the control module determining whether to calculate the coordinate value of the object according to whether the image information of the object captured by the first image capturing module or the second image capturing module is greater than the threshold value comprises the control module not calculating the coordinate value of the object when the image information of the object captured by the first image capturing module or the second image capturing module is less than the threshold value.

20. The image processing method of claim 18, further comprising the control module calculating the coordinate value of the object when the image information of the object captured by the first image capturing module or the second image capturing module is greater than the threshold value and the first image capturing module and the second image capturing module capture the image information of the object simultaneously.
